(19) United States
(12) Patent Application Publication
(10) Pub. No.: US 2010/0097181 A1
(43) Pub. Date: Apr. 22, 2010

(54) Patient Lifting System Using RFID Technology

(75) Inventors: Peter M. Sorensen, Bjaverskov (DK); Benny Nygård Jensen, Solrod Strand (DK)

Correspondence Address: POTOMAC PATENT GROUP PLLC, P. O. BOX 270, FREDERICKSBURG, VA, 22404, US

(73) Assignee: SHL MEDICAL AB, Nacka Strand (SE)

(21) Appl. No.: 12/088,841

(22) PCT Filed: Jul. 7, 2006
(86) PCT No.: PCT/EP06/64016

§ 371 Date: Mar. 31, 2008

Related U.S. Application Data
(60) Provisional application No. 60/697,372, filed on Jul. 8, 2005.

(51) Int. Cl. A61G 7/10; B66C 1/12; H04Q 5/22

(52) U.S. Cl. 340/10.1; 294/74

(57) ABSTRACT

An arrangement for a patient lifting system, wherein the patient lifting system comprises a lifting device and a sling adapted to be coupled to the lifting device. The lifting device is during use of the lifting system adapted to lift the patient from a lowered to a raised position and said sling is adapted to be at least partly wrapped around the patient to be lifted. The arrangement of the present invention comprises at least one RFID-chip (1) provided in the sling, at least one RFID-reader (2) adapted to communicate with the RFID-chip and at least one sensing means (3) provided in the sling and adapted to communicate with the RFID-chip. The RFID-chip is adapted to contain, to store and to continuously be updated with new or updated information that is relevant to the use of said sling in the patient lifting system and further adapted to provide said information to said RFID-reader. In a preferred embodiment the sling is provided with thermal sensing means adapted to communicate with the RFID-chip and further adapted to sense when the slings is being washed.

### TECHNICAL FIELD

The present invention refers to a patient lifting system, comprising a lifting device provided with a sling, wherein the sling, or another soft good article involved in the lifting of the patient, is provided with a Radio Frequency Identification (RFID)-chip and the user of the patient lifting system, or alternatively the lifting device itself, is equipped with a RFID-reader.

### BACKGROUND ART

Patient lifting systems that hoist invalids or incapacitated persons into the air are commonly known and have been used in the hospitals and within the healthcare industry for a number of years. Such a lifting system generally comprises a lifting device with a base and a frame, provided with a lifting arm that is adapted to be moved from a lowered position to a raised position. The lifting arm is adapted to be provided with a sling that at least partly is wrapped around the person to be lifted in order to support him or her as the person is hoist into the air. A patient lift provides a useful mechanism to move an incapacitated person from, for example, the bed to the wheel chair or to the bath. Compared to manually lifting the patients, patient lifting systems reduce the risk of accidents.

However, accidents do occur causing severe personal injury, mainly because of slings breaking or due to the fact that the wrong sling model is used for the specific lifting system. The lifting device may for instance be provided with a sling coupling means that may only couple with a specific sling. Such sling coupling means are generally mechanical solutions however, and they are unfortunately easily copied by unreliable companies. The use of a wrong sling in a specific lifting device, increases the risk of accidents, due to for instance an insufficient control of said sling, or due to the fact that the lifting device is not adapted to lift the sling in question.

The general sling, as well as other soft good articles involved in the lifting of the patient, such as fastening straps or the like, is often made of fabrics such as polyester, Nylon or non-woven polypropylene. Lifting and long time storage of such a fabric causes wear down which increases the risk of the sling breaking during lifting, even if manufactured by a reliable company. Since the patient lifting systems are generally used in the hospitals and in health care environments, there is also a need for washing the sling, as well as said other soft good articles, at high temperatures in order to avoid contamination and cross infection between patients, which further adds to the fabric wearing down due to the hot water and due to machine wear off.

The sling/article has therefore, depending on the specific sling/article and its fabric, a recommended life length, a recommended number of washings and a recommended number of uses as given from the manufacturer. When the sling/article is too old or has been used or washed the recommended number of times, the sling/article should be thrown away.

Attempts have been made to provide the sling with barcodes and fabric labels in printed form but the problem is that they disappear during normal usage and especially during washing in hot water. Consequently, a major part of the slings that are used today are too old since they are not replaced at end of life, because of the fact that the users, i.e. for instance the nurses or the care givers, can not see on the specific product how old it is, or how many times it has been used. It is also hard, or even impossible, to see how many times a sling has been washed, or if the sling as been stored for a long time, if the care givers are not keeping a record of such activities. Leading suppliers in the field estimate that as much as 20-35% of the sling population is too old and should be replaced.

US-A1-20010047283 discloses a printed tag including bar-code information, more exactly a serial number, relating a sling; a bar-code scanner capable of reading the bar-coded information; a remote computer operatively linked to the bar-code scanner; a host computer operatively linked to a remote computer; a database stored on the host computer, the database including the bar-coded information in non-bar-code format; and an input device operatively connected to the remote computer for updating the database with inspection information. It is even disclosed that the serial number can be transferred using a Radio Frequency Identification (RFID) tag. However, said RFID-tag is not adapted to store and continuously be updated with new or updated information.

As described by ways of introduction, accidents do occur, sometimes with fatal injuries, and it is therefore also a need for a better way of tracking and tracing the sling and its usage history during the investigation of the accident.

### SUMMARY OF THE INVENTION

The object of the present invention is to reduce the risk of accidents with a patient lifting system, comprising a lifting device provided with a sling, and/or a soft good article involved in the lifting of a patient, because of the use of a sling/article that is of risk of breaking during lifting of the patient, or should not be used due to any of the reasons as described above.

This object is achieved with an arrangement according to the preambles of the independent claims and provided with the features according to the dependent claims.

Another object of the present invention is to enhance the investigation of accidents already occurred and to give the organisation a better overview of the sling/article population within an environment.

### BRIEF DESCRIPTION OF THE DRAWINGS

FIG. 1 schematically describes the present invention according to a preferred embodiment with a thermal sensing means comprising a thermal electric module,

FIG. 2 schematically describes the present invention according to a preferred embodiment with a thermal sensing means in the form of a temperature sensor,

FIG. 3 schematically describes the communication between a RFID-chip, a RFID-reader and a database according to the present invention.

### DETAILED DESCRIPTION OF THE PRESENT INVENTION

The RFID-technology has been known and used since the 1970′ties. RFID-chips or tags can be described as small microchips acting as transponders, adapted to always listening for a radio signal sent by transceivers, or RFID-readers. When a transponder receives a certain radio query, it responds by transmitting its unique ID code, back to the transceiver. RFID chips do not require batteries but are powered by the radio signal that wakes them up and requests an answer.

The present invention refers to a patient lifting system, comprising a lifting device provided with a sling and/or a soft good article involved in the lifting of the patient, wherein the sling/article is provided with a RFID-chip 1. The RFID-chip could be any of the currently known and commercially available RFID-chips that are suitable for use in connection with the present invention, and that are adapted to store and continuously be updated with new or updated information.

Herein and after when reference is made to a sling, it should be interpreted as also to include a soft good article as described above involved in the lifting of a patient.

The user of the patient lifting device, i.e. for instance the hospital or the nursing home, will according to the present invention be equipped with a RFID-reader device 2, adapted to communicate with and read and update the information as transmitted from the RFID-chip. The RFID-reader can be any RFID-reader that is adapted to communicate with and read and update the RFID-chip incorporated into the sling, such as for instance a Personal Digitalized Assistant (PDA), a customized handset, or a Personal Computer (PC) etc. The RFID-reader is thus preferably provided with means, such as a display or the like, that in an effective way for the user presents the information as transmitted from the chip.

According to the present invention, the manufacturer of a sling incorporates at least one RFID-chip 1 into the sling, for instance during production thereof, and stores all the preferred available basic product information data in said chip, such as for instance information about:
Product data
Model number
Production Date
Serial Number
Batch Number
Information about the recommended life length of the sling
Recommended number of lifts,
Recommended number of washings
Instructions as how to use the sling

Further, the manufacturer of a sling incorporates at least one sensing means 3 into the sling, for instance during production thereof, wherein said sensing means is adapted to communicate with the RFID-chip.

When the sling, for instance, has been washed or used in an actual lift of a patient, the RFID can be updated with new information sent from the sensing means and/or the user, i.e. the nurse or the care giver for instance, can by means of the RFID-reader device update the RFID-chip with information about the event, and preferably also the date of the event. The RFID-chip is thus adapted to store and be provided with new or updated information, such as for instance information about:
Time Elapsed since production
First time in use in the lifting system
Number of times used in the lifting system
Number of times washed
Date for washing
Time of storage without use

It is to be understood that the lists above are not exhaustive lists, but that the person skilled in the art, easily can add other, or combine any of the product data as provided above, and end up with further product data that can be initially stored and updated in the RFID-chip.

Thus, when a sling is about to be used, the user reads the information in the RFID-chip by means of the RFID-reader and is provided with all the necessary information from the chip. The user is thus in an effective and reliable way provided with information if the sling should be used or thrown away. For instance, if the user is provided with the information that the sling has been used and/or washed a number of times exceeding the recommended, or if the recommend life length of the sling is exceeded, the user is provided with the information that the sling should be thrown away. The user may also be provided with information and instructions about how to use the sling. The user may for instance be untrained and/or lack professional experience and can by means of the display in the RFID-reader be provided with instructions, in text as well as in explaining pictures, as how to for instance connect the sling to the lifting device or how to properly place the patient in the sling. The skilled person can readily come up with several suggestions for user instructions provided to the user by means of the RFID-reader.

According to a preferred embodiment of the present invention, the sensing means of the sling is provided with a thermal sensing means, integrated with and adapted to communicate with the RFID-chip.

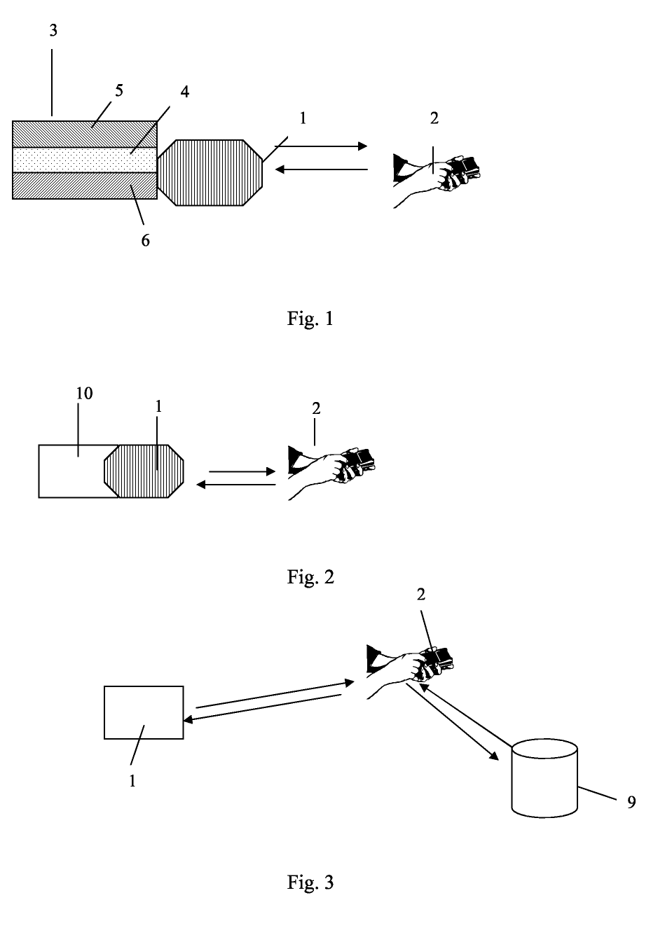

The thermal sensing means can be in the form of a thermal electric module 4, such as for instance peltier, surrounded by two different materials 5, 6 with different characteristics and mechanical properties, such as for instance Fe, Cu/Ni, Ni/Cr, Ni/Al, Ni, Cu/Ni, see FIG. 1. According to the present invention, when the sling, and thus the thermal sensing means, is washed in, and affected with hot water, the two materials 5 and 6, respectively, will be subjected to different reactions, such as temperature, i.e. the thermal sensing means has the function of a thermal element. The different reaction in the two materials is detected and information about that the sling has been washed, is transferred to the RFID-chip, which stores said information and the chip is in this way preferably also adapted to store information about the date of washing.

The thermal sensing means 3 of the present invention, as described above, is thus adapted to detect when the sling has been subjected to a temperature that corresponds to the temperature of the washing water, generally in the range of 40-100° C., and adapted to transfer that information to the RFID-chip, without the need for any external power source. This procedure is repeated continuously every time the sling is washed.

The thermal sensing means 3 of the present invention, can also be in the form of a thermal sensor 10 integrated with the RFID-chip, which sensor by means of temperature detects if the sling is washed, see FIG. 2. The thermal sensor can be any type of thermal sensor that operates within the above mentioned temperature range of the washing water. If the thermal sensor needs to be provided with an external power, such an external power source can readily be provided in the sling in connection with the thermal sensor, for instance in the form of a battery or the like, if needed provided in a suitable water-proof casing. As described above, the thermal sensing means is thus adapted to detect when the sling has been subjected to a temperature that corresponds to the temperature of the washing water, and adapted to transfer and update the chip with information that the sling has been washed, and preferably also with information about the date of washing. This procedure is repeated continuously every time the sling is washed.

Thus, if the sling is provided with a thermal sensing means 3 as described above, the user of the sling, when reading the RFID-chip by means of the RFID-reader, her or she is provided with information about the number of washes of the sling, preferably also the date of washing, and if said number exceeds the recommended, the user is provided with the information that the sling should be thrown away. It is also possible that the RFID-chip is provided with means, that when provided with information that the sling has been washed, it will decrease the recommended life-length of the sling with for instance a predetermined number of days.

Having a thermal sensing means incorporated into the sling will increase the safety aspects, since the possibility that the sling user forgets to update the RFID-chip with information about the wash is effectively eliminated.

When the sling has been used in an actual lift of the patient, the user can manually update the chip with information about the use of the sling, such as for instance the date of use, by means of the RFID-reader as described above. However, in a further preferred embodiment, the lifting arm for instance, or another part of the lifting device that is adapted to be used in the lifting of the chip-provided sling, is provided with a RFID-reader in a for this embodiment suitable form, such as a RFID-reader integrated with the lifting device with a customized display. In said embodiment, the RFID-reader is provided with means that are adapted to communicate with the RFID-chip and automatically update said chip with the information that sling has been used in a lift, and preferably also the date of the use, when this event occurs. This will greatly reduce the risk of the user forgetting to update the RFID-chip with information about the use of the sling.

In said further preferred embodiment, the lifting arm or another part of the lifting device that is adapted to be used in the lifting of the chip-provided sling, is preferably further provided with lift preventing means adapted to communicate with said RFID-reader, that will prevent the lifting device to be operated, i.e. in this instance used in an actual lift of the patient, if the RFID-reader is provided with information from the chip in the sling, for instance when said sling is coupled to the lifting device, that the recommended life length of the sling has exceeded or if the sling should not be in use due to any of the other reasons as described above. It could also be that the wrong sling is coupled to the lifting device or that the sling is coupled to the lifting device in an incorrect way. That is to say, that the lifting device is prevented to be operated if it does not receive a clear signal from the RFID-chip in the sling. In the latter case, the user may also preferably provided with information or instructions, se above, as how to correct whatever caused the non-clearance signal from the chip. If the sling is not provided with a chip, naturally no signal is to be transmitted to the RFID-reader and the lifting device can not be operated. The latter will greatly reduce the risk of wrong slings being used in a specific lifting system, the problem with which was described by ways of introduction.

The RFID-chips as described in connection with any of the embodiments above are preferably adapted to continuously communicate with a database 9 via the RFID-readers, see FIG. 3. The database is thus at all times provided with the latest current status of the sling population within an environment. Said database is thus provided with means adapted to store the usage history of each and every one of the chip-provided slings adapted to communicate with the database. An authorized user of the database is thus in an effective way provided with information about the status and usage history of the slings. This will greatly enhance for instance the investigation of occurred accidents or give the organization a better over view of the age of a given population of slings.

Also the sling supplier with access to the data base is in an effective way provided with information about the slings from manufacturing to the end of life, which will give them the opportunity to optimize supply chain management to the benefit for the user and the environment and this will also help them to face out old slings.

It is to be understood that the invention is not restricted to the above described embodiments thereof and that several conceivable modifications are possible within the scope of the following claims.

1-10. (canceled)

11. An arrangement for a patient lifting system having a lifting device and a sling, the lifting device being adapted to lift the patient from a lowered position to a raised position and the sling being adapted to be coupled to the lifting device and to assist the patient when lifted, the arrangement comprising:
at least one radio frequency identification (RFID) chip provided in the sling;
at least one RFID reader adapted to communicate with the at least one RFID chip; and
at least one sensor provided in the sling and adapted to communicate with the at least one RFID chip;
wherein the at least one RFID chip is adapted to contain, to store, and to be updated with information that is relevant to use of the sling and is further adapted to provide the information to the at least one RFID reader.

12. The arrangement of claim 1, wherein the information in the at least one RFID chip is chosen from a group comprising production date of the sling, serial number of the sling, model number of the sling, batch number of the sling, recommended life length of the sling, recommended number of uses of the sling in the lifting system, recommended number of washings of the sling, use instructions of the sling, time elapsed since production of the sling, date of first use of the sling, number of times the sling has been used in the lifting system, number of times the sling has been washed, and date for washing of the sling.

13. The arrangement of claim 11, wherein the at least one RFID reader is adapted to read and to update the information contained in the at least one RFID chip and is further adapted to provide the at least one RFID chip with new information and to provide the information to a user of the at least one RFID reader.

14. The arrangement of claim 11, wherein the at least one sensor comprises a thermal sensor adapted to detect when the sling has been washed, and upon detection that the sling has been washed, to provide the at least one RFID chip with information that the sling has been washed.

15. The arrangement of claim 11, wherein the at least one RFID reader is provided at the lifting device, is adapted to detect when the sling is used in the lifting system, and upon detection that the sling is used, to provide the at least one RFID chip with information that the sling has been used in the lifting system.

16. The arrangement of claim 15, wherein the at least one RFID reader is adapted to provide the at least one RFID chip with information about a date that the sling is used in the lifting system.

17. The arrangement of claim 15, wherein the lifting device is further provided with a lift preventer that is adapted to communicate with the at least one RFID reader and to automatically prevent the lifting device from being used to lift the patient if the at least one RFID reader is provided with information, from the at least one RFID chip in the sling intended to be used to lift the patient, that the sling should not be used.

18. The arrangement of claim 11, further comprising a readable database adapted to communicate with the at least one RFID reader and to contain and store information contained and stored in the at least RFID chip and/or the at least one RFID reader.

19. A sling for a patient lifting system having a lifting device and the sling, the lifting device being adapted to lift the patient from a lowered position to a raised position, the sling comprising:
a radio frequency identification (RFID) chip; and
a thermal sensor adapted to communicate with the RFID chip, to detect when the sling has been washed, and upon detection that the sling has been washed, to provide the RFID chip with information that the sling has been washed;
wherein the sling is adapted to be coupled to the lifting device and to assist the patient when lifted.

20. A lifting device for a patient lifting system having a sling and the lifting device, the sling being adapted to be coupled to the lifting device and to assist the patient when lifted, the lifting device comprising:
a radio frequency identification (RFID) reader; and
a lift preventer adapted to communicate with the RFID reader and to automatically prevent the lifting device from being used to lift a patient if the RFID reader is provided with information that the sling should not be used.
